(19) United States
(12) Patent Application Publication
(10) Pub. No.: US 2014/0365888 A1
(43) Pub. Date: Dec. 11, 2014

(54) USER-CONTROLLED DISASSOCIATION AND REASSOCIATION OF AUDIO AND VISUAL CONTENT IN A MULTIMEDIA PRESENTATION

(71) Applicant: Narrable, LLC, Tulsa, OK (US)

(72) Inventor: Dustin Curzon, Tulsa, OK (US)

(73) Assignee: NARRABLE, LLC, Tulsa, OK (US)

(21) Appl. No.: 14/296,744

(22) Filed: Jun. 5, 2014

Related U.S. Application Data
(60) Provisional application No. 61/831,279, filed on Jun. 5, 2013.

(51) Int. Cl. G06F 3/0484; G06F 3/16; G06F 3/0485

(52) U.S. Cl. CPC G06F 3/0484; G06F 3/0485; G06F 3/16
USPC 715/716

(57) ABSTRACT

Presentation systems and methods are provided for the presentation of visual and audible content on an electronic device with a display screen. An array of images is displayed, moving sequentially through the array absent user interaction. Audio content associated with each image is presented as the associated image is selected for presentation. The presentation of visual content can be disassociated from the presentation of audio content by allowing a user to manually scroll through the array of images without disrupting the sequential playback of audio content. Selection of a user interface element causes the visual display of images to scroll back within the array until an image associated with currently-playing audio content returns to the display screen.

### TECHNICAL FIELD

The present disclosure relates in general to electronic multimedia presentations, and in particular to user-controlled disassociation and reassociation of visual and audio content during a multimedia presentation.

### BACKGROUND

Digital photography has exploded in popularity in recent years with the prevalence of digital cameras, particularly as individuals increasingly carry mobile telephones having camera capabilities. Accordingly, a variety of services have been implemented to assist in the processing, organization and presentation of digital photos.

One possible form of photo presentation is the organization of a collection of related photos. The related photos may be presented electronically in a format typically referred to as a slideshow. The slideshow format typically advances through photos in a predetermined sequence and timing. The slideshow may additionally include an audible component, such as background music. In some slideshow presentations, the background music advances in a predetermined sequence with the photo presentation, such that pausing the presentation results in the pausing of both the photos and associated audible content. In other slideshow presentations, once the slideshow begins, the audio content is decoupled from the visual content; for example, background music may play continuously, regardless of whether the viewer pauses the presentation of visual images.

### SUMMARY

A computer-implemented method is provided for presenting audio and visual content on a user electronic device having a display screen and audio output, and is typically adapted for communications via a digital communications network such as the Internet. Exemplary user electronic devices may include personal computers, tablet computers and smart phones. The method includes the step of initiating the presentation of an array of digital images, such as photographs, on the device display screen. The images are transmitted to the user electronic device via the electronic communications network. The presentation begins with a first one of the digital images, and proceeds automatically through the array. Audio content associated with the digital images is transmitted to the user electronic device via the electronic communications network for playback via the audio output. A first user interface component is provided on the display screen, the actuation of which enables disassociation of the images from the playback of audio content by scrolling within the array of digital images such that an image associated with audio content extends outside a viewable area of the array of images. A second user interface component is provided on the display screen, the actuation of which causes the automatic scrolling within the array of images such that an image associated with presently-playing audio content falls within the viewable area on the display screen. In some embodiments, a third user interface component can be provided for display on each of the digital images within the viewable area of the display screen, selection of which causes the transmission of audio content associated with the digital image on which the selected third user interface component is displayed. The audio content may be comprised of previously-recorded audio segments, one or more of which may be associated with each digital image. The step of transmitting audio content may further include the substeps of, for an image having one or more previously-recorded audio segments associated with it, transmitting the audio segments; and for an image not having previously-recorded audio segments associated with it, pausing playback of audio content for a predetermined period of time.

Also disclosed is a media presentation service hosted on one or more servers, at least one of the servers having a processor and memory storing instructions which, when executed by the processor, cause the server to perform a method which includes the step of initiating the presentation of a subset of a sequenced array of digital images on a display screen of a user electronic device communicating with the server via the Internet, the presentation beginning with a first one of said digital images and proceeding automatically through the array. Audio content associated with the digital images is transmitted to the user electronic device, along with instructions for initiating playback of the audio content by the user electronic device. Further instructions are transmitted to the user electronic device for causing the display of a first user interface component viewable on the user interface device display screen. Selection of the first user interface component causes scrolling within the array of digital images without disrupting the playback of audio content, such that an image associated with active audio content move outside of the viewable area on the display screen. Further instructions are transmitted to the user electronic device for causing the display of a second user interface component, the selection of which causes automatic scrolling within the array of images such that an image associated with presently-playing audio content falls within the viewable area on the display screen. Further instructions may be transmitted to the user electronic device for causing the display of a third user interface component on each of the digital images within the viewable area of the display screen, selection of which causes the server to transmit audio content associated with the digital image on which the selected third user interface component is displayed.

Also disclosed is an electronic computing device for presenting visual and audible content. The device includes a display screen, a processor, and digital memory for storing instructions which, when executed by the processor, cause the electronic computing device to present an array of digital images, displaying a subset of the images on the display screen at any given time. Audio content associated with images within said array of images is automatically played back sequentially. Absent user interaction, the displayed subset automatically advances through the array of images to maintain an image associated with played audio content within the displayed subset. A user is enabled to scroll the displayed subset of images within the array of images, without interrupting the sequential playback of audio content. A user interface element is displayed when an image associated with audio content being played back is no longer within the displayed subset, selection of the user interface element causing the displayed subset to automatically scroll through the array of images to encompass the image associated with audio content being played back.

### BRIEF DESCRIPTION OF THE FIGURES

FIG. 1 is schematic block diagram of an information system for presentation of multimedia content

FIG. 2 is a schematic block diagram of a sequential array of photos.

FIGS. 3, 4, 5, 6, 7, 8 and 9 are web browser user interface displays in accordance with one embodiment.

FIGS. 10, 11 and 12 are web browser user interface displays in accordance with a further embodiment.

FIG. 13A through 13E are schematic block diagrams illustrating a correlation between presentation focus and display area in accordance with a further embodiment.

### DESCRIPTION OF THE PREFERRED EMBODIMENTS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Another format for a multimedia presentation includes a collection of digital visual images, and also a collection of audio content. In one exemplary application, the visual images may be, for example, digital photos, while the audio content may be composed of narrated segments, where each narrated segment is associated with one of the digital photos. The photos and associated audio content may be accessed via the Internet and presented via a web application.

For example, a recently married couple may prepare a collection of digital photos of their wedding and upload the photos via the Internet to a web application running on a server in a hosting facility. For some or all of the uploaded photos, the couple may then record a narrated audio segment associated with a photo. With the narrated segment, the couple, family or friends can describe aspects of the photo, such as what was happening, what events led up to the photographed moment, what occurred after the photographed moment, and/or what the participants were thinking or feeling during those times.

The completed multimedia presentation may then be presented via a web browser. In one form of presentation, the set of photographs is displayed in a scrollable browser pane which extends horizontally, with only a portion of the pane being visible at a time. The horizontal pane may be scrolled left and right, either by the user manually or via automated progression, to view the complete set of materials. In the exemplary embodiment, by default, once started, the presentation proceeds automatically from left to right. Each photo is displayed while any associated audio content is played. As an associated audio segment is completed, the set of photos scrolls along the horizontal pane as the viewer focus moves to the next photo and audio content associated with the next photo begins playing. This process may continue throughout the set, as photos are displayed and associated audio content is played.

Such sequential presentation of visual and associated audio content may be useful. However, in some circumstances, users may wish to consume such multimedia content in a nonlinear way. For instance, in the wedding photo and narration example described above, a wedding guest may wish to skip around within the presentation to target photos and audio associated with specific events or people, without taking time to watch the entire presentation. A user may decide to skip around to different points in the presentation during the course of playback by scrolling left or right within the horizontal photo pane. The photos provide instant visual cues that may be rapidly interpreted by a user in order to efficiently identify audio content that may be desired by the user. For example, perhaps the user is not interested in the narrated content associated with a particular photo. The user can click on another photo having subject matter of interest to the viewer in order to skip to audio content more likely to be of interest to the viewer. Automatic playback may resume from that point. Alternatively, a user having limited time or specific interests may use web browser scrolling tools to skip around within the photo set to view specific photos within the set and listen to their associated audio content.

The scrollable photo pane described above effectively disassociates the visual presentation from the audio presentation. While this disassociation provides a rich experience for the user, it may also present challenges for the user in navigating the presentation content. For example, a user may briefly view a photo and begin listening to a narrated story associated with that photo. The user may then wish to scroll around the photo pane to view other photos while still listening to the previously-initiated audio segment. Meanwhile, if an audio segment is completed, the presentation may automatically advance to the next audio segment, even while the visual presentation in the photo pane is disassociated from the audio. A problem may arise if the user wishes to return the photo presentation pane to the photo in the set that is associated with the currently-playing audio. In a large photo set, it may be challenging to find the location of the photo associated with the currently-playing audio segment.

In order to provide improved user navigation in such a multimedia presentation in which the presentation of audio and visual content may be manually disassociated, navigation aids may be provided to the user in order to automatically reassociate the presentation of audio and visual content.

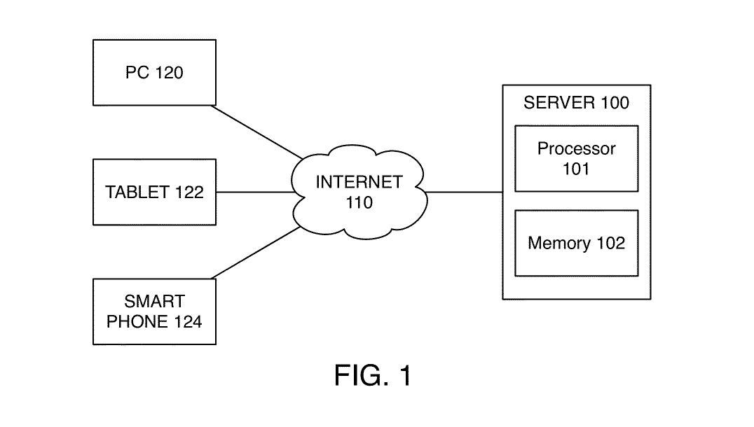

The Figures illustrate exemplary embodiments of the concepts described herein. FIG. 1 is a schematic block diagram of an information system within which the present system can be implemented. Server 100 is a computer system executing a web application and communicating to other computers via Internet 110. Server 100 includes microprocessor 101 and digital memory 102 for, inter alia, storing instructions that can be executed by processor 101. While depicted in the schematic block diagram of FIG. 1 as a block element, as known in the art, server 100 may be implemented in a variety of ways, via distributed hardware resources and using any of multiple different software stacks. In a preferred embodiment, server 100 may be implemented via a software stack including Backbone.js, Ruby on Rails, CSS3 and HTML5. System data may be stored in a MySQL database. Preferably, photo and audio content is stored in a cloud storage platform, such as Amazon S3. Server hardware may be provided by a cloud hosting company. Application users access server 100 via user devices such as personal computer 120, tablet computer 122 and smart phone 124. The user devices execute software including a web browser application, for displaying information on a display screen and outputting audio information via speakers or other audio output. The functionality described below is implemented via execution of software on, and communication of data between, server 100 and user devices 120, 122 and 124.

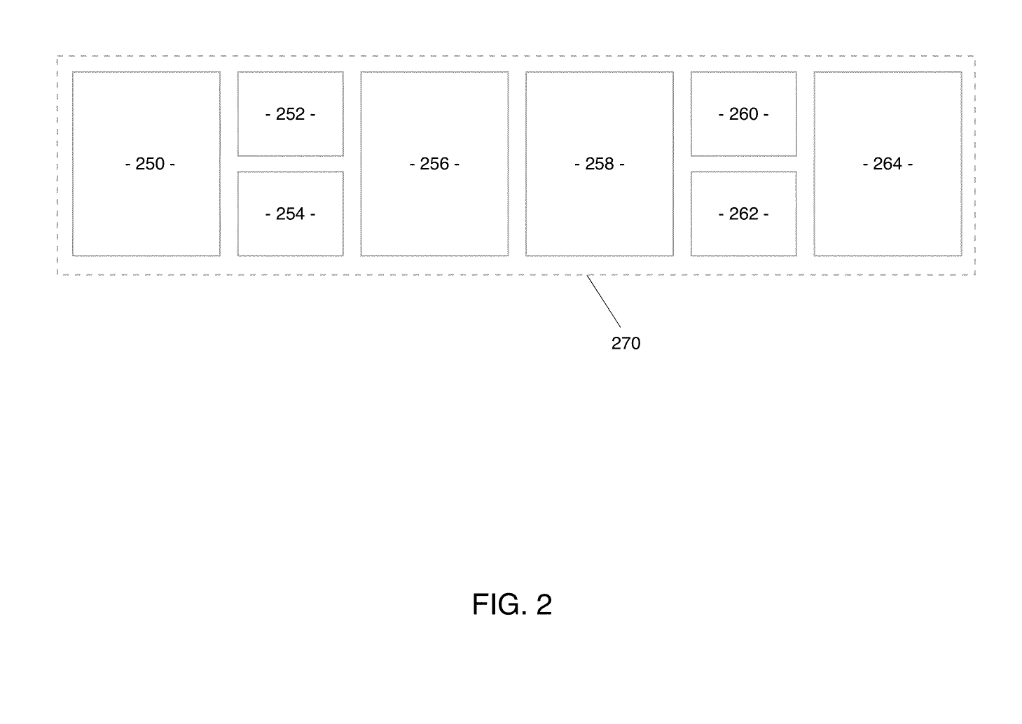

FIGS. 2 through 9 illustrate one exemplary embodiment having a horizontally-arranged sequence of photos with associated audible content. FIG. 2 is a schematic block diagram of digital photos 250 through 264, oriented in a horizontal array. The sequential collection of photos 250 to 264 may be hereafter referred to collectively as photo sequence 270. The photo sequence of FIG. 2 may include various elements stacked vertically, such as photos 252 and 254. Preferably, the photos are associated with a predetermined sequence moving from left to right and top to bottom, e.g., in ascending reference designator order within FIG. 2. That said, it is contemplated that other sequential orders could be employed in other embodiments. For example, for a service targeted to cultures that traditionally read right to left, a right-to-left sequence may be desirable. Alternatively, a photo presentation could be arranged in a vertical orientation, where photos proceed sequentially, and can be manually scrolled, in an up-down arrangement.

Each of the photos in photo sequence 270 may optionally have a segment of audible content associated with it. Digital photos 250-264 and associated audible content segments are stored digitally within server 100, preferably within a cloud data storage platform such as Amazon S3.

The audible content associated with photos 250-264 may be a single recording or multiple recordings. For example, in some embodiments, photo 250 may include a single recording of audible content narrated by a single individual. In other embodiments, photo 250 may include multiple recordings of audible content, each narrated by a different individual describing the same photograph. It is contemplated that different mechanisms for handling audible content playback can be provided, whether by default or user configuration. In some embodiments, the one or more recordings of audible content associated with each photo can be played back sequentially, prior to the playback focus moving on to the next photo. Alternatively, modes of operation can be implemented in which a subset of audio recording associated with a particular photo are played back, which subset can be determined randomly, by user configuration, or via other desired criteria.

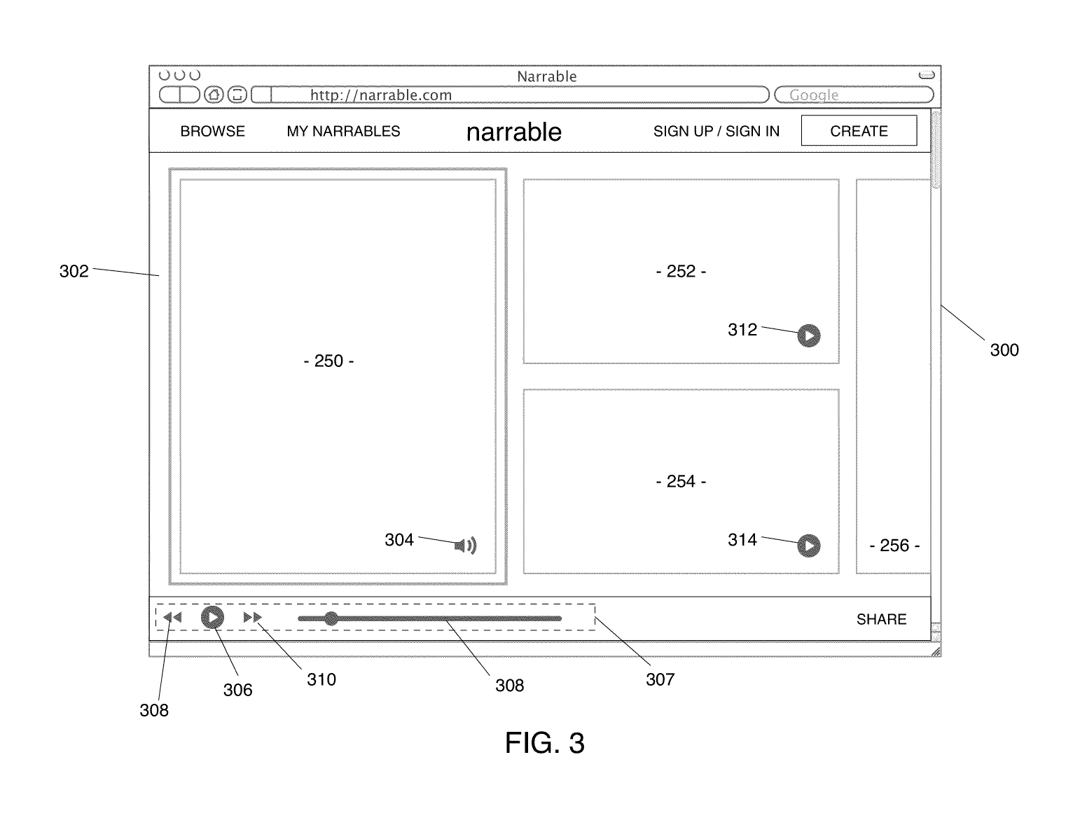

FIG. 3 illustrates a portion of photo sequence 270 as displayed within presentation pane 302 of web browser 300. Web browser 300 is implemented by a user device, such as PC 120, tablet computer 122 and smart phone 124, with the associated web browser output displayed on a display screen associated with a user device.

In FIG. 3, presentation pane 302 presents the beginning portion of photo sequence 270, while web browser 300 and its associated user device outputs associated audible content. First photo 250 is displayed on the lefthand portion of pane 302, with photos 252 and 254, and a portion of photo 256, displayed to the right of photo 250. Speaker icon 304, overlaying a portion of photo 250, provides a visual indication to a user that audio content associated with photo 250 is being presented. Pause icon 306 is depicted in control pane 307, to provide a user with play/pause functionality over the audio content. Play progress bar 308 provides a visual indication to a user of the playback progress through the currently-playing audio content, while further providing users with the ability to skip to a user-selected point within the audio material. Back button 309 and forward button 310 allow users to skip backward and advance forward, respectively, through photos in sequence 270 and their associated audio content.

Additional icons are presented overlaying photos within sequence 270 to provide users with an indication of which photos have audio content associated with them, and to provide a mechanism to immediately initiate playback of such associated audio content. For example, Play icon 312 indicates the presence of audio content associated with photo 252, and selection of play icon 312 will cause server 100 to initiate playback of audio content associated with photo 252 via Internet 110 and a user device, such as PC 120 implementing web browser 300. Similarly, play icon 314 indicates the presence of, and enables immediate playback of, audio content associated with photo 254.

In some modes of use, a user may allow the presentation to play through. Audio content associated with photos within sequence 270 is presented sequentially, with photo sequence 270 automatically scrolling to maintain presentation focus of the photo associated with current audio content within pane 302 of web browser 300.

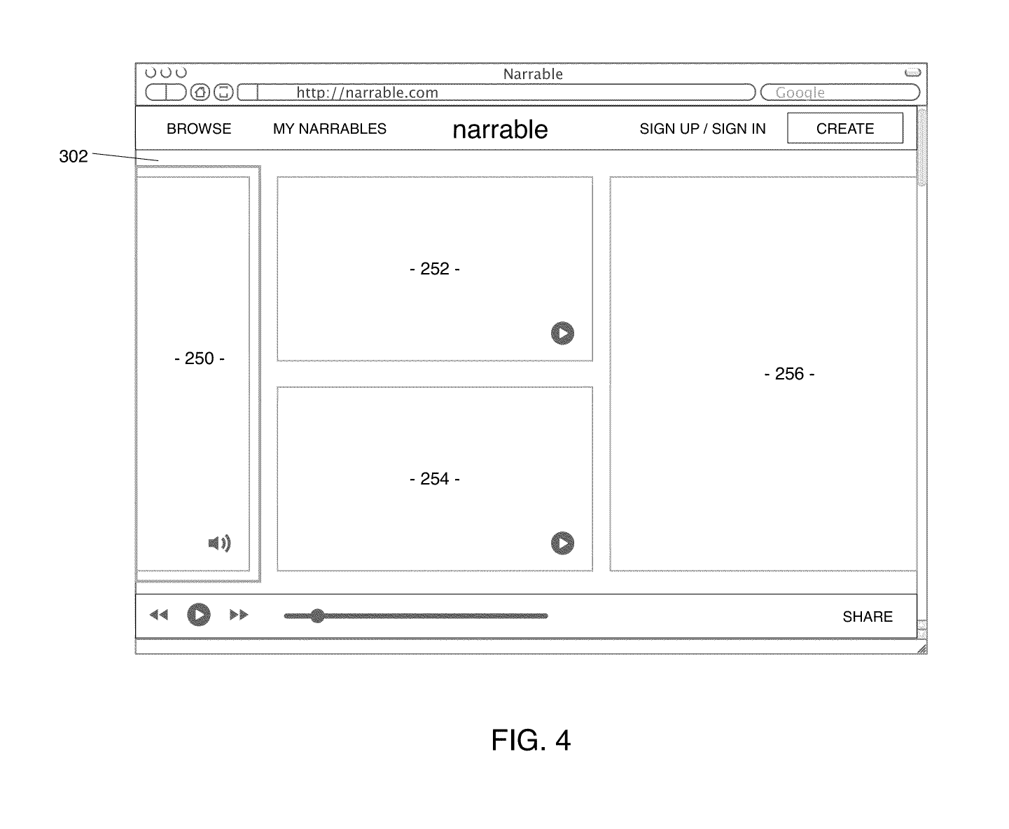

Alternatively, the user may wish to de-associate the presentation of visual content from the presentation of audio content. For example, a user may wish to scroll to the left or to the right of a photo for which audio content is currently playing. In FIG. 4, the user has scrolled presentation pane 302 to the right, such that a portion of photo 250 for which associated audio content is being played is extended off the left hand border of pane 302. Meanwhile, more of photo 256 is revealed. A user can continue consuming the audio content associated with photo 250 while simultaneously viewing other photos within photo sequence 270.

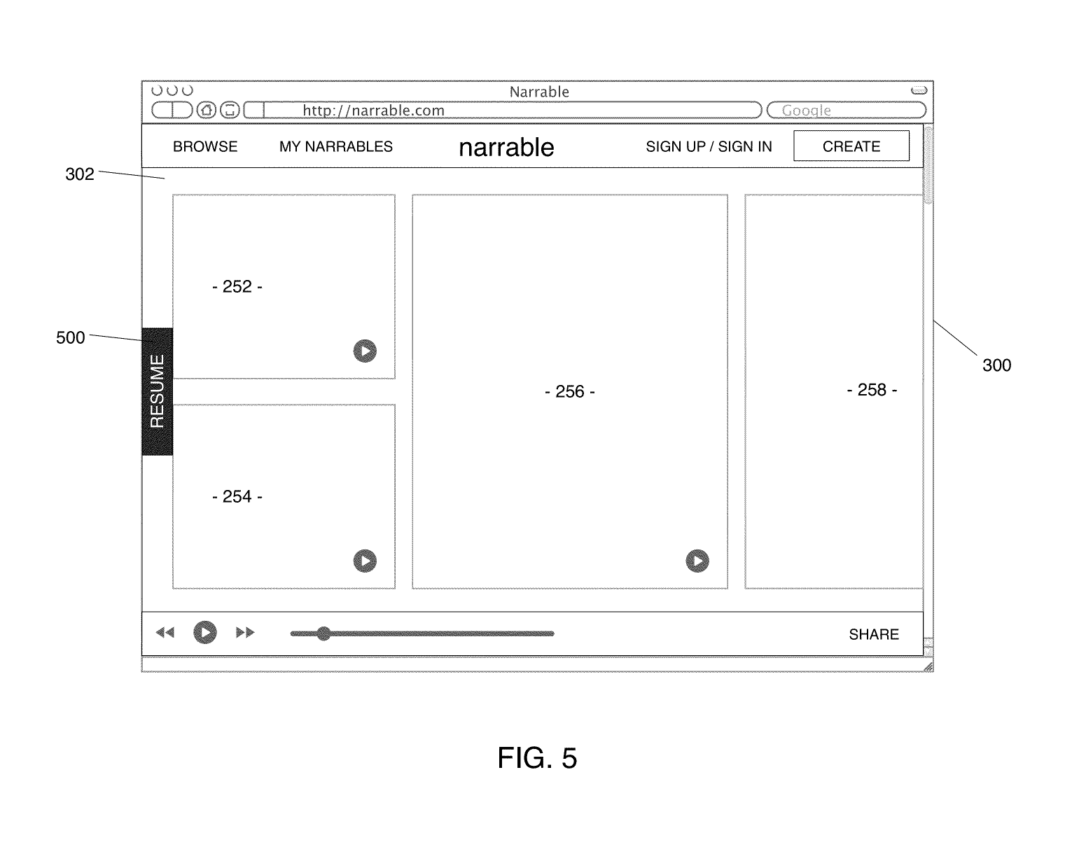

As a user continues scrolling presentation pane 302 to the right and viewing additional photos in sequence 270, photo 250 for which audio content is being played will eventually roll off the left hand edge of presentation pane 302. This scenario is depicted in FIG. 5.

As a user moves through a lengthy sequence of photos, at some point the user may wish to re-associate the presentation of visual and audio information, such as by returning the view within presentation pane 302 to the position corresponding to a photo for which audio content is playing. For example, a user may wish to continue listening to a narrated story even after they are finished viewing the photo with which the story is associated. The viewer may then deassociate audio and visual information by scrolling around the photo presentation to, e.g., enjoy other photos or search for specific photo content of interest. But when the user wishes to return to the photo associated with current audio content, it may be difficult to easily locate the associated position within photo sequence 270. Users may become frustrated attempting to locate the current photo.

Accordingly, it may be desirable to provide navigational aids in order to enable a user to automatically re-associate the presentation of visual content with the presentation of audio content. To that end, re-association button 500 is presented along the edge of presentation pane 302 closest to the photo within sequence 270 that is associated with presently-playing audio content. In FIG. 5, browser 300 is playing audio content associated with photo 250, which is scrolled off the left edge of pane 302. Therefore, button 500 is presented along the left edge of pane 302. A user can select button 500 (i.e. via clicking a mouse by a user of PC 120, or via selection using a touchscreen user interface of tablet 122 or smart phone 124), in which case browser 302 automatically scrolls the display of photo sequence 270 within pane 302 until the presentation of visual content is reassociated with the currently-playing audio content. Accordingly, selection of button 500 in the embodiment of FIG. 5 causes the photo sequence display to shift back to that illustrated in FIG. 3.

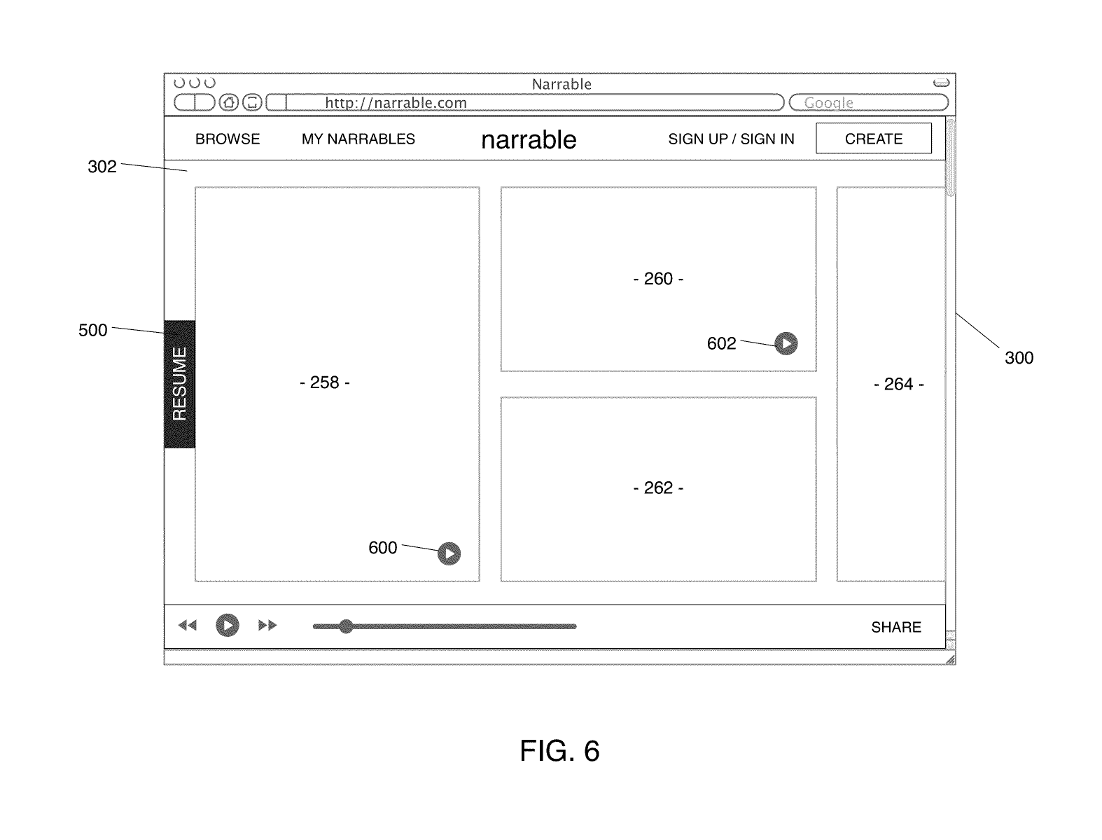

In FIG. 6, the user has continued scrolling to the right within pane 302. Photos 258 and 260 include play icons 600 and 602, respectively, which enable a user to interrupt the current presentation of audio content and initiate the presentation of audio content associated with photo 258 or 260. Photo 262 does not have a play icon, thereby indicating to the user that this particular photo does not have audio content associated with it.

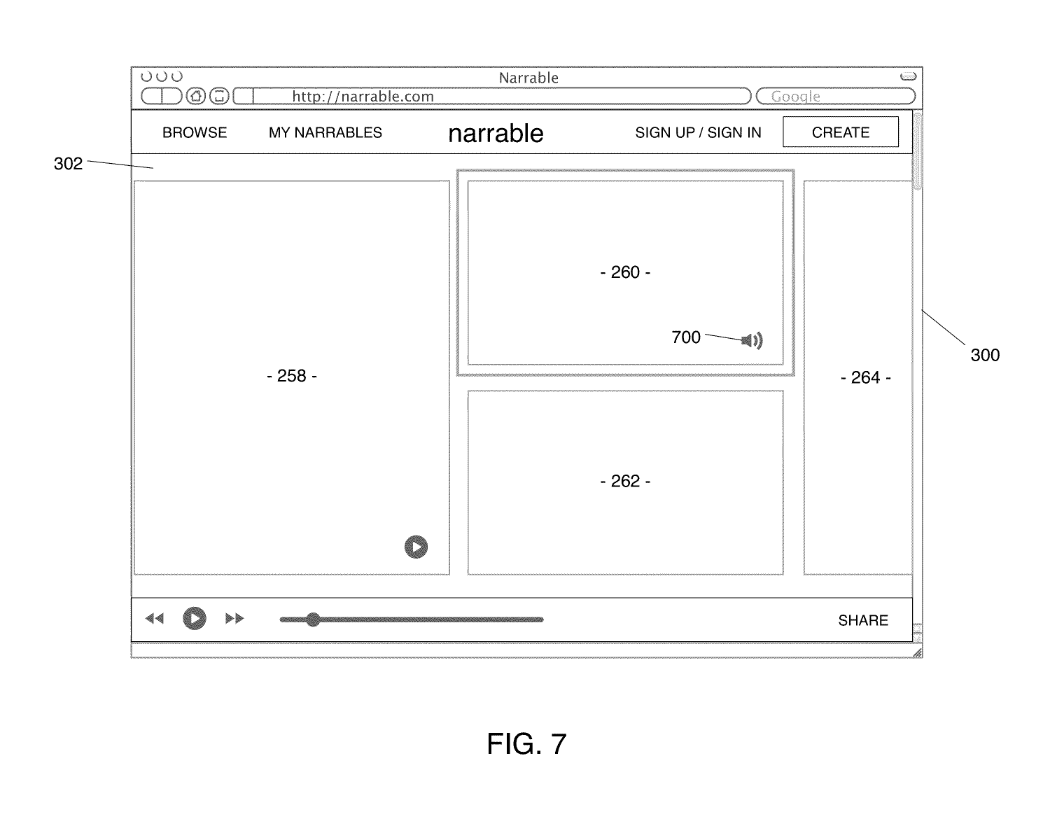

In FIG. 7, the user has selected play icon 602, thereby initiating presentation of audio content associated with photo 260. Speaker icon 700 takes the place of play icon 602 to indicate to the user that browser 300 has begun playback of audio content associated with photo 260.

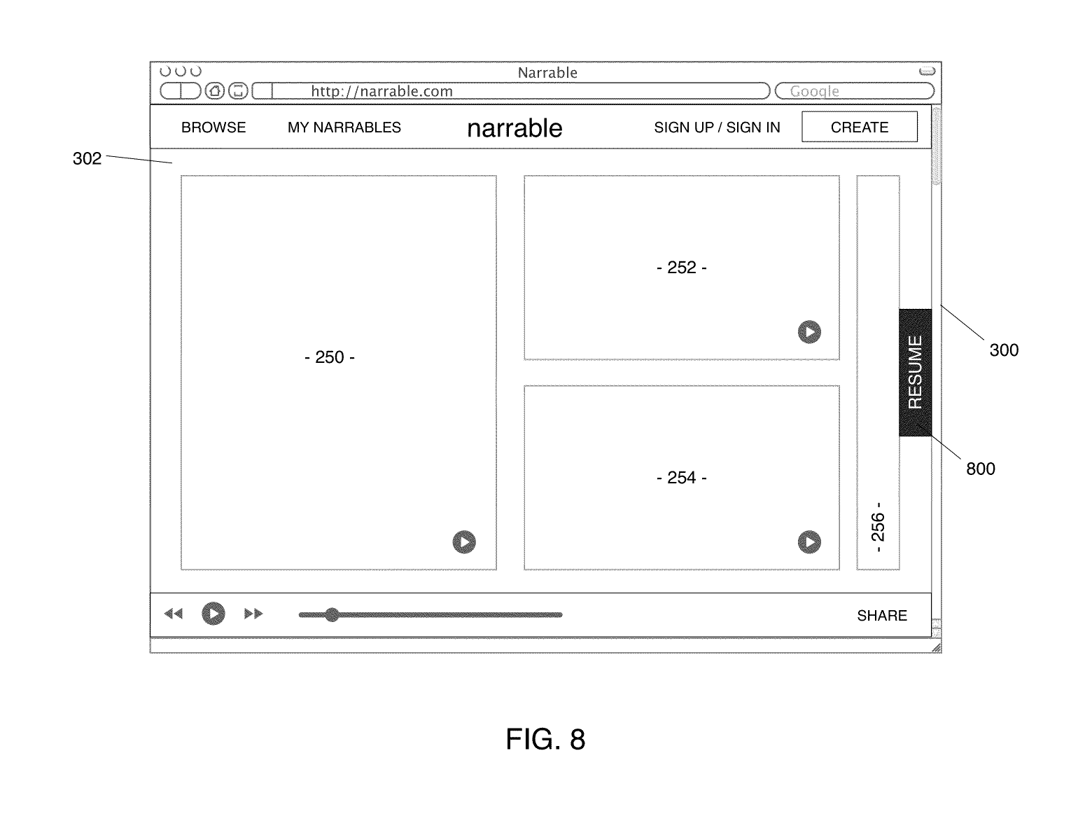

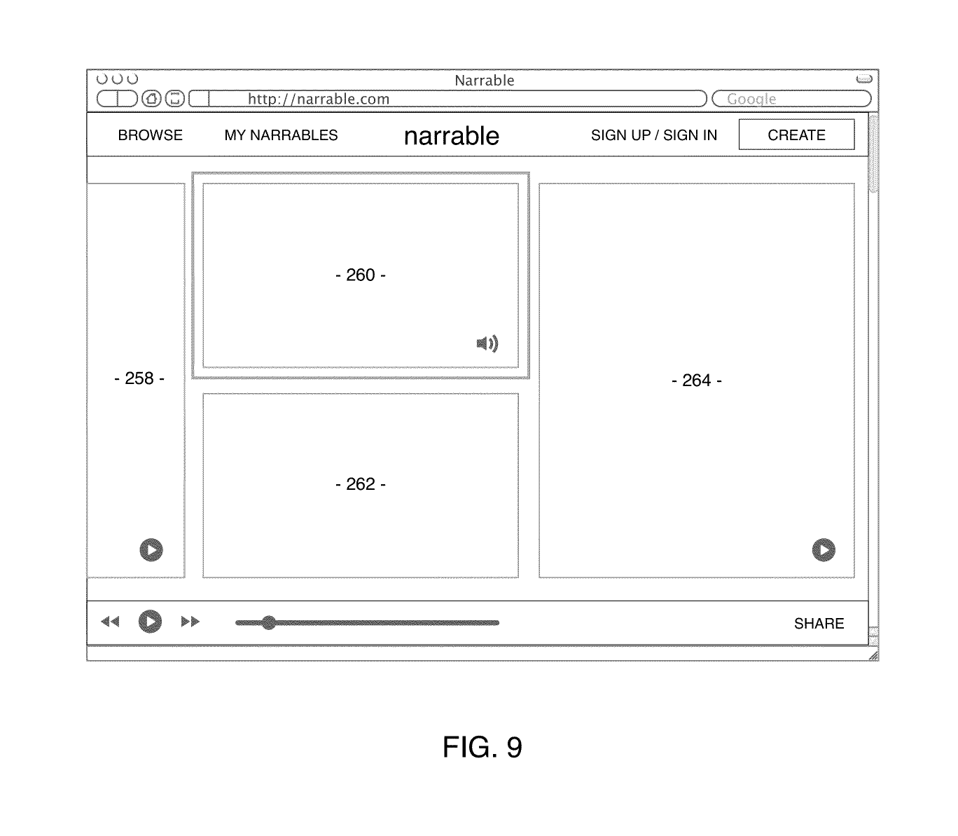

In FIG. 8, the user has scrolled left within pane 302 while browser 300 is playing audio content associated with photo 260. Reassociation button 800 is displayed along the right hand edge of pane 302, providing a viewer with a visual cue as to the direction of the photo associated with presently-playing audio content. Selection of button 800 causes the display within pane 302 to automatically scroll right, until photo 260 is once again presented within pane 302, i.e. the view of FIG. 9.

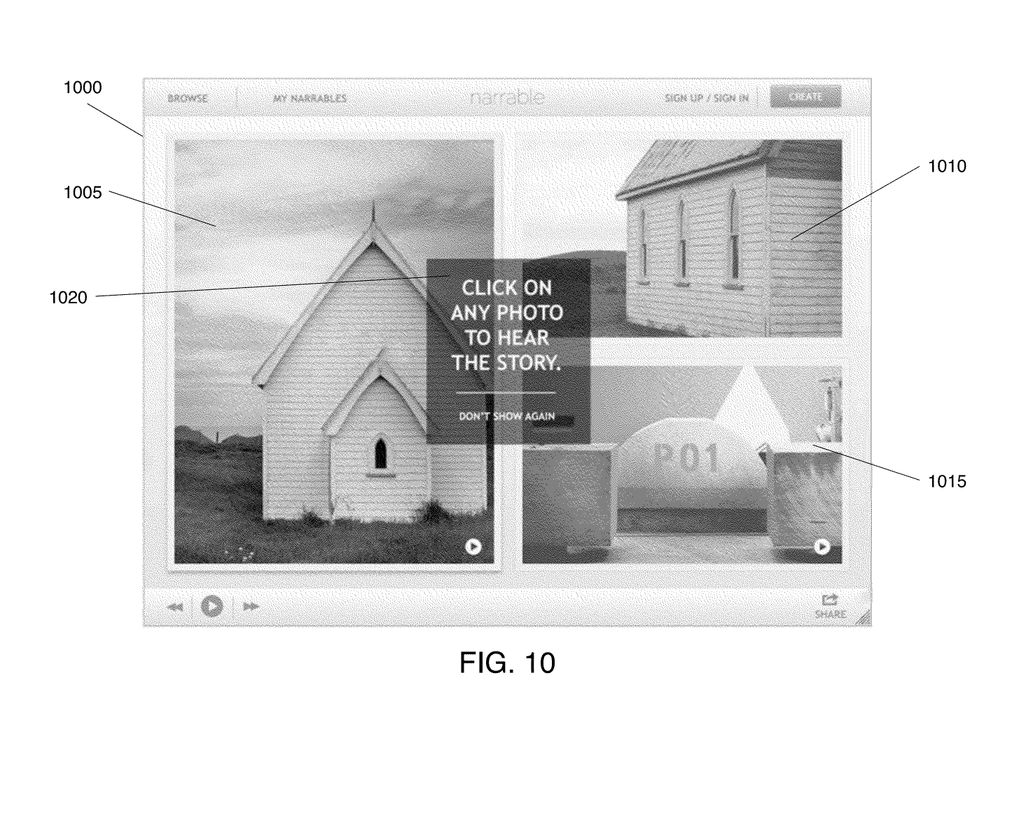

Another embodiment is illustrated in FIGS. 10-12. FIG. 10 illustrates a user interface rendered via web browser window 1000 upon first opening a multimedia sequence. Browser 1000 displays a sequence of photos 1005, 1010 and 1015. The user is further presented with overlay instructional message 1020. The user can begin playback of a multimedia sequence by clicking anywhere on one of photos 1005, 1010 and 1015.

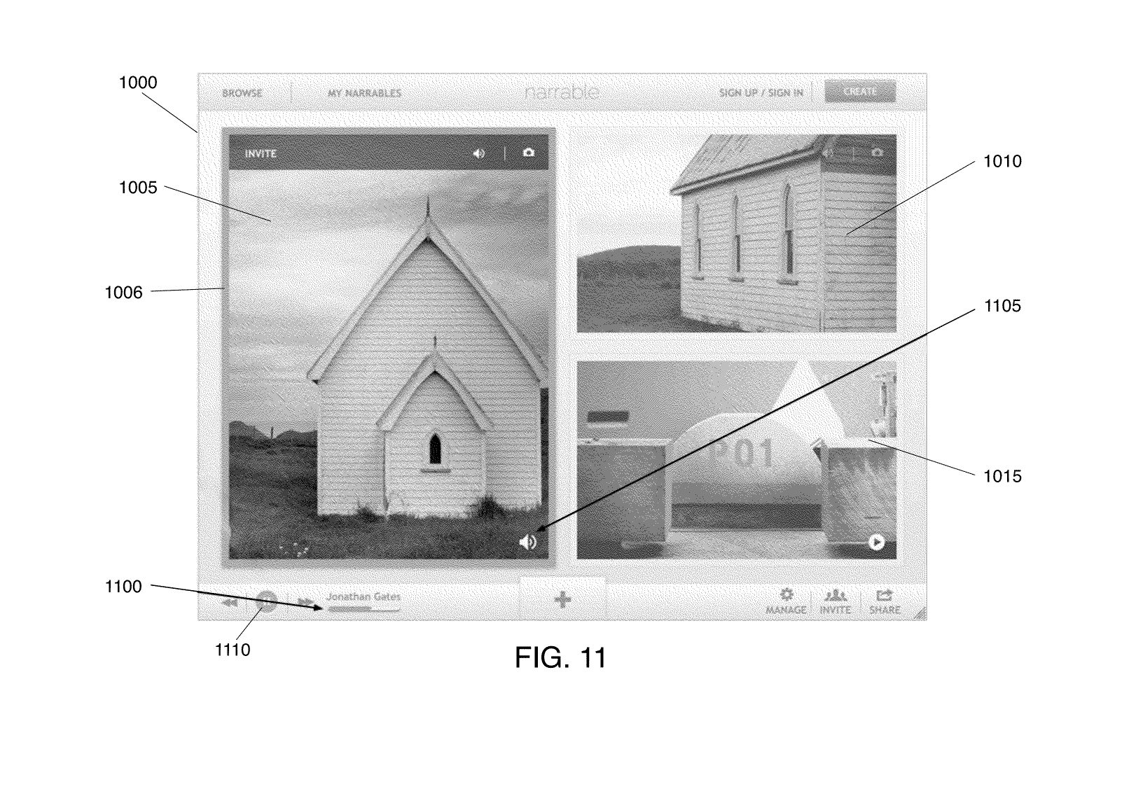

FIG. 11 illustrates the embodiment of FIG. 10 after overlay instructional message 1020 has been dismissed, and the user has selected photo 1005 to initiate playback. A colored border 1006 is displayed surrounding photo 1005, as a readily discernible indicia to the user of the photo associated with current audio playback. Audio indicator 1100 is rendered within browser 1000 to provide a user indication of the individual associated with the audible material currently being played back (in this case, an individual named Jonathan Gates), and a progress bar below the speaker's name indicating the proportion of the audible content that has been played back relative to the amount remaining. Speaker icon 1105 overlying a portion of photo 1005 provides a further visual indication that audible content being played back is associated with photo 1005. Meanwhile, clicking anywhere on photo 1005 or playback control 1110 can pause and resume playback of audible content associated with photo 1005.

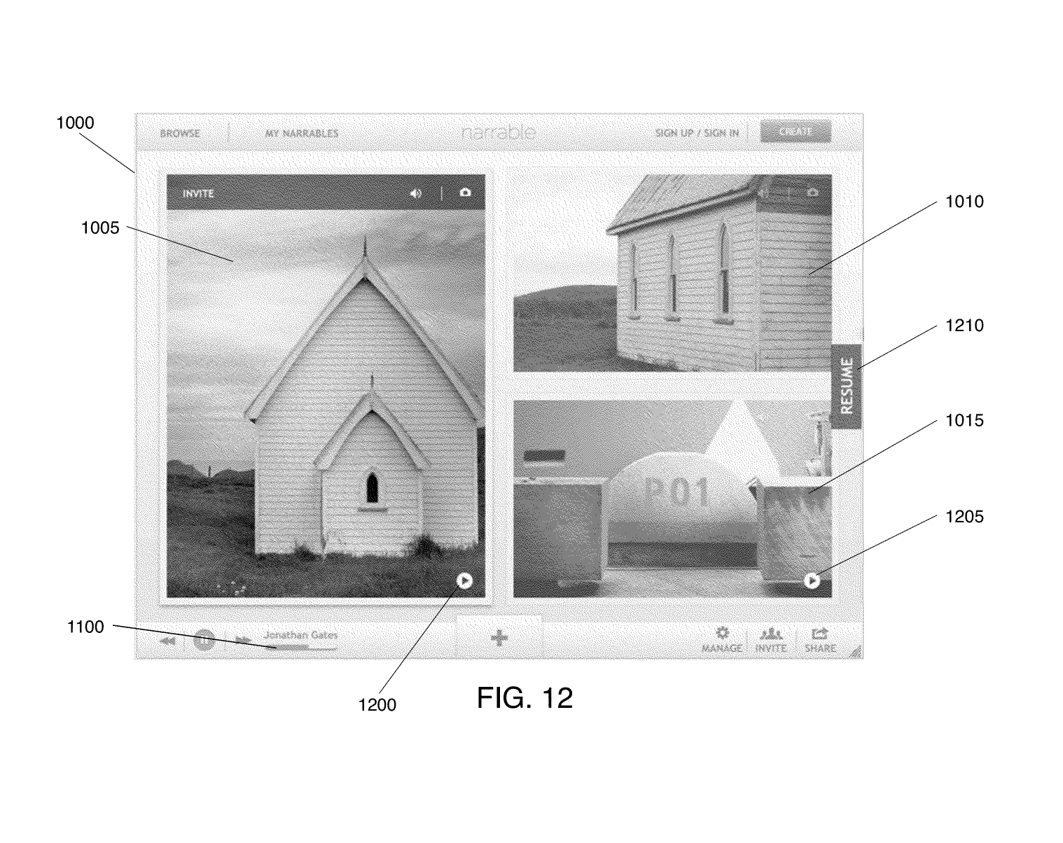

In FIG. 12, playback has continued through photos 1005, 1010 and 1015, on to additional photos in the sequence to the right (not shown). Meanwhile, the user has scrolled left in the sequence back to the beginning. Colored border 1006 is no longer displayed around photo 1005, as audible content playback has progressed to other photos. Play icons 1200 and 1205 can be selected by a user to transition audio playback to content associated with photo 1005 and 1015, respectively. The absence of a play icon overlaying photo 1010 indicates an absence of audible content associated with that photo. Resume button 1210 is rendered along the righthand edge of the display, the position of which is indicative that presently-playing audible content is associated with a photo further right in the sequence. Selection of resume button 1210 by a user will automatically scroll the photo sequence to the right, so that the photo associated with presently-playing audible content is within browser window 1000.

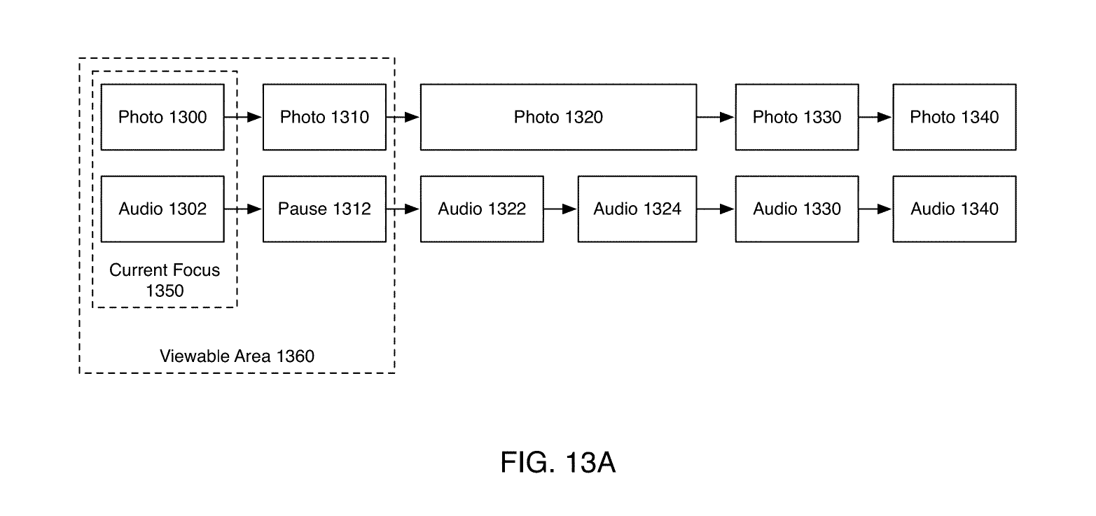

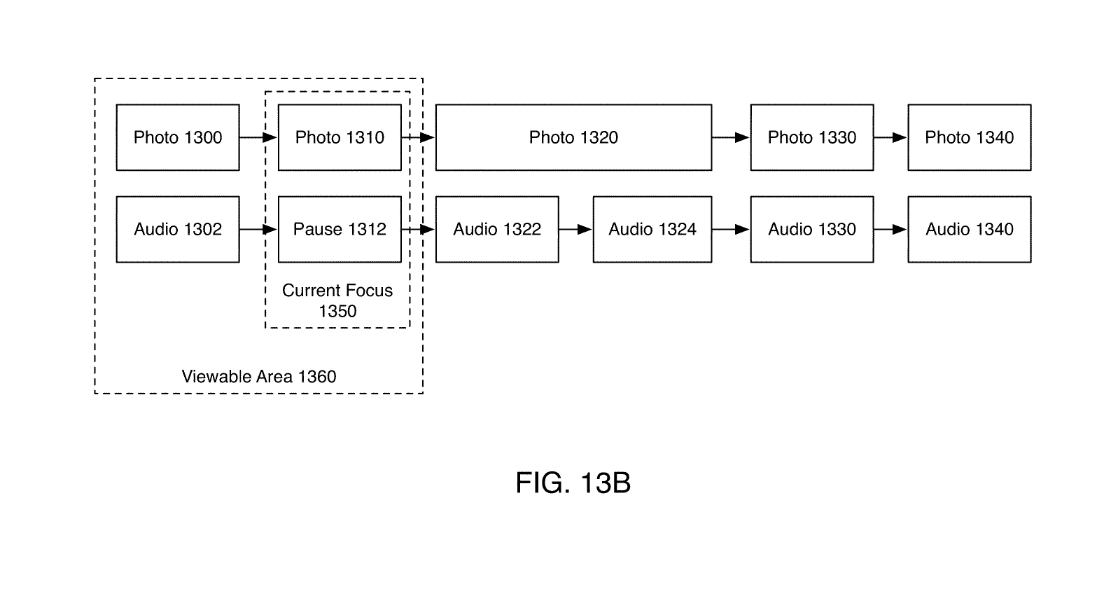

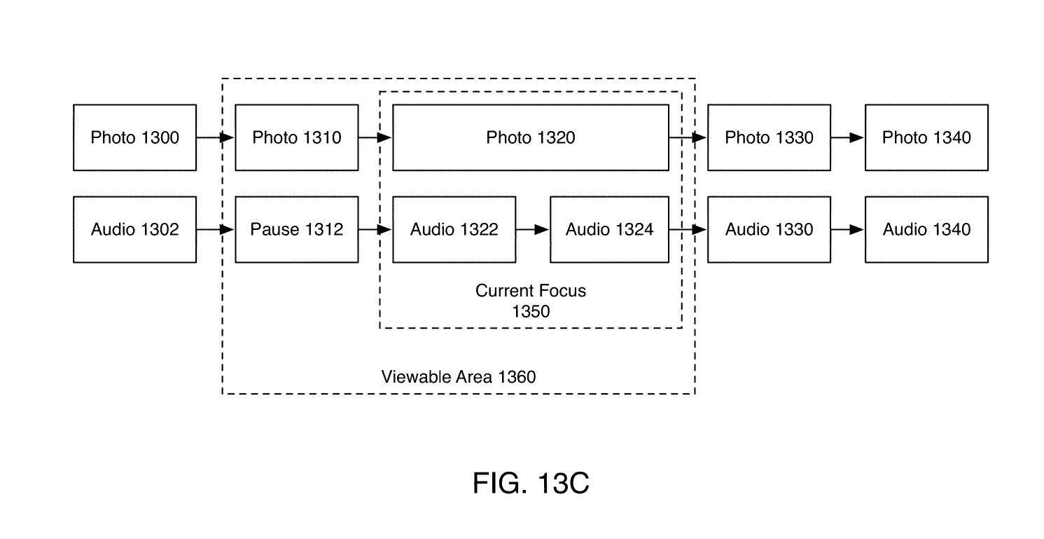

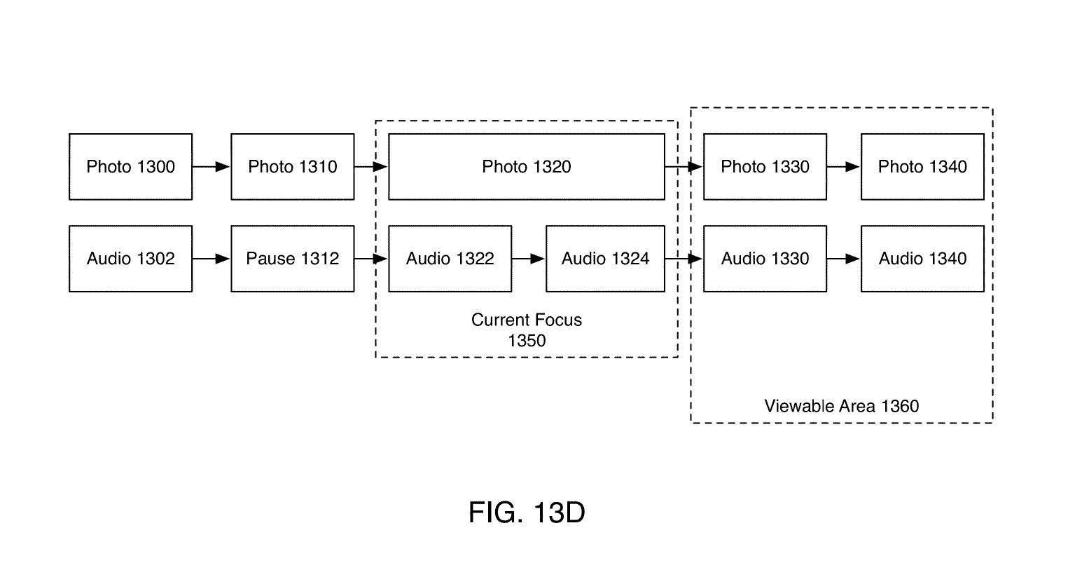

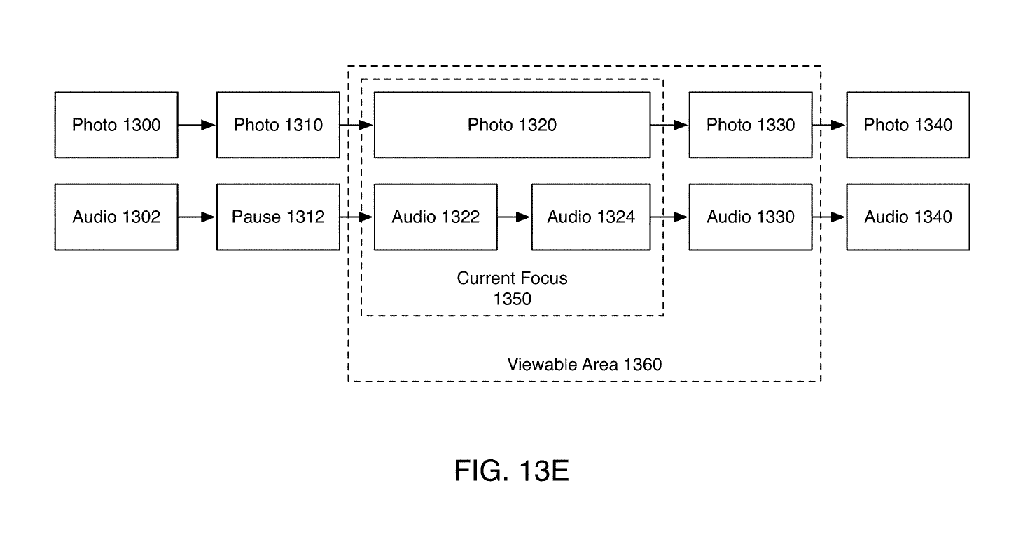

In accordance with another exemplary embodiment, FIG. 13A-E are schematic block diagrams illustrating the variable association between presentation focus and viewable area on a user device. The presentation focus refers to a current position within a presentation sequence, which typically advances automatically unless/until that progression is modified by a user action. Audible content associated with the presentation focus, if any, is subject to playback. Viewable area refers to a portion of the presentation sequence that is displayed on a user device at a particular moment in time. In FIG. 13A, by default, the progression starts with the display on a user device of the first photo in the set, photo 1300, and playback of associated audio content 1302. Thus, current focus 1350 encompasses photo 1300 and audio 1302. The user device in the embodiment of FIG. 13 displays two photographs at any given time. In the arrangement of FIG. 13A, viewable area 1360 encompasses photos 1300 and 1310. While default operation begins playback of the multimedia sequence at photo 1300 and audio content 1302, the user can manually start the progression from any photo, such as by selection of a play icon associated with the photo. Any photo can have one or more audio narrations associated with it. The focus stays on a photo for the length of the associated audio clip(s). If no audio is present, the focus pauses on the photo for a preferably predetermined number of seconds.

In FIG. 13B, once playback of audio content 1302 is complete, focus 1350 moves to the next photo in the progression, photo 1310. Photo 1310 does not have audio content associated with it; in lieu of audio content, pause 1312 is provided to cause current focus 1350 to rest on photo 1310 for a predetermined period of time. Meanwhile, viewable area 1360 continues to encompass photos 1300 and 1310.

On-screen buttons may be rendered on the user device to move current focus 1350 to the next or previous photo. In the embodiment of FIG. 13, use of on screen buttons to move forward or backward within the sequence does not trigger disassociation of current focus 1350 from viewable area 1360. Thus, the transition from the state of FIG. 13A to the state of FIG. 13B could also have been initiated by selection of an on-screen button to move forward within the sequence, rather than simply waiting for completion of playback of audio content 1302.

As long as no manual input is detected to scroll around within the presentation sequence, viewable area 1360 moves automatically with focus 1350. FIG. 13C depicts a state after completion of pause 1312. Current focus 1350 advances automatically to photo 1320 and its associated audio segments 1322 and 1324, while viewable area 1360 advances to encompass photos 1310 and 1320.

FIG. 13D illustrates a state in which the user has scrolled to the right within the presentation sequence, while playback of audio content 1322 and/or 1324 continues. Current focus 1350 remains on photo 1320 and its associated audio content. However, the user has scrolled the viewable area to encompass photos 1330 and 1340, such that the viewable area disassociates from the playing progression. Focus 1350 continues its progression regardless of user-controlled position of viewable area 1360. Meanwhile, a user interface component, such as a button, is made available to the user, preferably towards the left hand side of the user interface to indicate the position of current focus 1350 relative to viewable area 1360, to initiate reassociation, analogous to the scenario illustrated in FIG. 6. FIG. 13E illustrates a state in which the user has selected such a user interface component to trigger reassociation of viewable area 1360 with current focus 1350, at which point the realigned viewable area will resume automatically following the progression. Progression continues to photo 1330 and 1340 until after the presentation of the final photo and its associated audio. Then the progression stops until started again by the user.

Through certain embodiments described herein, a system and method is described which enables the presentation of visual content and audio content associated therewith in a way that the user can alternatively disassociate and reassociate the presentation of visual content with the presentation of audio content.

While certain system infrastructure elements are illustrated in particular configurations, it is understood and contemplated that functional elements can be readily integrated and/or implemented via various alternative hardware or software abstractions, as would be known to a person of skill in the field of information systems design. For example, while some of the above described embodiments include presentation of content via a web browser, it is contemplated and understood that a standalone PC application, or a smart phone or tablet computer app, could be implemented in order to present audio and video content as described hereinabove. As another example, while certain embodiments may present audio information via streaming of audio data from server 100 to a user device via the Internet, in other embodiments, it may be desirable to store content locally on the user device prior to initiating presentation. These and other variations are contemplated.

Moreover, while certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the appended claims.

What is claimed is:

1. A computer-implemented method for presenting audio and visual content on a network connected user electronic device having a display screen and audio output, comprising the steps of:
initiating the presentation of an array of digital images on the display screen, said images being transmitted to the user electronic device via an electronic communications network, the presentation beginning with a first one of said digital images and proceeding automatically through the array;
transmitting audio content associated with said digital images to the user electronic device via an electronic communications network for playback via said audio output;
providing a first user interface component viewable on the display screen, the actuation of which enables disassociation of said images from said playback of audio content by scrolling within said array of digital images such that an image associated with audio content extends outside a viewable area of said array of images;
providing a second user interface component viewable on the display screen, the actuation of which causes the automatic scrolling within said array of images such that an image associated with presently-playing audio content falls within a viewable area on the display screen.

2. The method of claim 1, further comprising the step of:
providing a third user interface component on each of said digital images within a viewable area of the display screen, selection of which causes the transmission of audio content associated with the digital image on which said selected third user interface component is displayed.

3. The method of claim 1, in which said audio content is comprised of previously-recorded audio segments, one or more of which may be associated with each digital image.

4. The method of claim 3, in which the step of transmitting audio content is further comprised of the substeps of:
for an image having one or more previously-recorded audio segments associated therewith, transmitting said audio segments;
for an image not having previously-recorded audio segments associated therewith, pausing playback of audio content for a predetermined period of time.

5. A media presentation service hosted on one or more servers, at least one of the servers having a processor and memory storing instructions which, when executed by the processor, cause the server to perform a method comprising:
initiating the presentation of a subset of a sequenced array of digital images on a display screen of a user electronic device communicating with the server via the Internet, the presentation beginning with a first one of said digital images and proceeding automatically through the array;
transmitting audio content associated with said digital images to the user electronic device, along with instructions for initiating playback of said audio content by the user electronic device;
transmitting instructions to the user electronic device for causing the display of a first user interface component viewable on a display screen associated with the user electronic device, the selection of which causes scrolling within said array of digital images without disrupting the playback of audio content, such that an image associated with active audio content moves outside a viewable area of said array of images;
transmitting instructions to the user electronic device for causing the display of a second user interface component viewable on the display screen, the selection of which causes automatic scrolling within said array of images such that an image associated with presently-playing audio content falls within the viewable area on the display screen.

6. The media presentation service of claim 5, wherein the memory stores further instructions, which, when executed by the processor, cause the server to:
transmit instructions to the user electronic device for causing the display of a third user interface component on each of said digital images within a viewable area of the display screen, selection of which causes the server to transmit audio content associated with the digital image on which said selected third user interface component is displayed.

7. An electronic computing device for presenting visual and audible content comprising:
a display screen, a processor, and digital memory for storing instructions which, when executed by the processor, cause the electronic computing device to perform a method comprising:
presenting an array of digital images, displaying a subset of the images on the display screen at any given time;
automatically sequentially playing audio content associated with images within said array of images;
absent user interaction, automatically advancing the displayed subset through the array of images to maintain an image associated with played audio content within the displayed subset;
enabling a user to scroll the displayed subset of images within the array of images, without interrupting the sequential playback of audio content;
displaying a user interface element when an image associated with audio content being played back is no longer within the displayed subset, selection of the user interface element causing the displayed subset to automatically scroll through the array of images to encompass the image associated with audio content being played back.

8. The electronic computing device of claim 7, wherein the memory stores further instructions which, when executed by the processor, cause the device to perform a method in which the user interface element is displayed at a position within the display screen indicative of the position of the image associated with audio content being played back in the array of images, relative to the displayed subset.
